(19) United States
(12) Patent Application Publication
(10) Pub. No.: US 2010/0265066 A1
(43) Pub. Date: Oct. 21, 2010

(54) Actively Protecting an Area

(76) Inventor: Maly Edelman, Tel Aviv (IL)

Correspondence Address: The Law Office of Michael E. Kondoudis, 888 16th Street, N.W., Suite 800, Washington, DC, 20006, US

(21) Appl. No.: 12/808,211

(22) PCT Filed: Dec. 16, 2008
(86) PCT No.: PCT/IL08/01625

§ 371 Date: Jun. 15, 2010

(30) Foreign Application Priority Data
Dec. 16, 2007 (IL) 188156

(51) Int. Cl. G08B 13/00

(52) U.S. Cl. 340/541

(57) ABSTRACT

An active protection system and a method of protecting an area from trespassers. The system comprises a sensing unit arranged to detect the presence and the location of the trespasser, a targeting unit and a discharging unit arranged to discharge a charge onto the trespasser detected by the sensing unit according to data from the targeting unit. The charge is selected to neutralize or mark the trespasser.

### CROSS REFERENCE TO RELATED APPLICATION

This application claims the benefit of Israeli Patent Application 188156 filed on Dec. 16, 2007, which is incorporated herein by reference.

### TECHNICAL FIELD

The present invention generally relates to the field of security. More particularly, the present invention relates to protecting areas and objects from trespassers.

### BACKGROUND OF THE RELATED ART

Security systems are very common nowadays for domestic use as well as in industrial or national security buildings. Sensors may be connected to a control unit via either a low-voltage hardwire or narrowband RF signal, which is used to interact with a response device. The most common security sensors indicate the opening of a door or window or detect motion via passive infrared (PIR). Sophistication ranges from small, self-contained alarms, to complicated, multi-zoned systems with color-coded computer monitor outputs.

The following patents and patent applications, disclosing security systems and intruder detection systems, are incorporated herein by reference: U.S. Pat. No. 4,079,862, WIPO Publication No. W09324910, U.S. Pat. No. 6,734,789, WIPO Publication No. W02004109614, U.S. Pat. No. 4,604,607, Japanese Patent Document No. JP2003217044, Swedish Patent Document No. SE512775, Japanese Patent Document No. JP2004176523, U.S. Pat. No. 4,118,691, U.S. Pat. No. 5,402,000, U.S. Pat. No. 5,280,268, U.S. Pat. No. 4,903,863, German Patent Document No. DE4133110, German Patent Document No. DE4236458, European Patent Document No. EP0645644, German Patent Document No. DE19717022, U.S. Pat. No. 4,055,277.

### BRIEF SUMMARY

Embodiments of the present invention provide an active protection system for protecting an area against at least one trespasser. The active protection system comprises a sensing unit, a targeting unit, and a discharging unit. The sensing unit is arranged to detect the presence and the location of the at least one trespasser in the area. The targeting unit is arranged to target the direction of the discharging unit onto the at least one trespasser. The discharging unit is arranged to discharge a charge onto the at least one trespasser. The targeting unit is arranged to target the discharging direction of the discharging unit onto the at least one trespasser, by identifying the presence and the location of the at least one trespasser in the area as detected by the sensing unit.

Accordingly, according to an aspect of the present invention, the area may be defined around at least one object.

Accordingly, according to an aspect of the present invention, the sensing unit is arranged to detect contact between the at least one trespasser and the at least one object.

According to another aspect of the present invention, the charge may comprise at least one of: paint, at least one paintball, oil, glue, a capsule, a solid object, a bullet, gas, tear gas, fluid, a paralyzing substance, a neutralizing substance, electric charge and foamed polyurethane.

According to another aspect of the present invention, the charge may be an electric charge and the discharging unit may be arranged to discharge the electric charge to the at least one trespasser by at least one of: utilizing contact between the at least one trespasser and the at least one object and from a distance.

According to yet another aspect of the present invention, the sensing unit may comprise at least one of: a direction sensor, a direction and distance sensor, a signal transmitter relating to a signal receiver, a camera arranged to sample and compare images, a vicinity sensor, a contact sensor, a motion sensor, a laser beam and a mechanical motion sensor.

Embodiments of the present invention provide a method of protecting an area against at least one trespasser. The method may comprise: detecting the presence and the location of the at least one trespasser in the area; targeting at least one discharging unit onto the at least one trespasser; and discharging at least one charge onto the at least one trespasser. The targeting may be carried out according to the detected presence and location data. The discharging of the at least one charge may be carried out according to the targeting.

According to an aspect of the present invention, the method may further comprise enabling the at least one trespasser to avoid the discharging by identification and authentication of the identification of the at least one trespasser.

According to an aspect of the present invention, discharging the at least one charge may comprise at least one of: pouring; spraying; spreading; releasing; propelling; firing; throwing; splashing; spilling; shooting; and releasing, at least one of: paint, at least one paintball, oil, glue, a capsule, a solid object, a bullet, gas, tear gas, fluid, a paralyzing substance, a neutralizing substance, electric charge, foamed polyurethane.

According to another aspect of the present invention, the method may further comprise distinguishing the at least one trespasser from other persons in the vicinity of the protected area.

According to another aspect of the present invention, the method may further comprise activating objects in the vicinity of the protected area.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “FIGS.”), wherein:

FIG. 1 is a block diagram illustrating an active protection system for protecting an area against trespassers, according to some embodiments of the invention;

FIG. 2 is an illustration of a protected area around an object (e.g. a painting) protected by an active protection system, according to some embodiment of the invention;

FIG. 3 is an illustration of an object, protected by an active protection system, according to some embodiments of the invention;

FIG. 4 is an illustration of an assembly of objects located in a predefined area, protected by an active protection system, according to some embodiments of the invention;

FIG. 5 illustrates a rear view of a plurality of discharging units installed upon a wall, according to some embodiments of the invention;

FIG. 6 is an illustration of an object, protected by an active protection system, according to some embodiments of the invention;

FIG. 7 is an illustration of an object, protected by an active protection system, according to some embodiments of the invention;

FIG. 8 is an illustration of a room protected by an active protection system, according to some embodiments of the invention;

FIG. 9 is a top view of the active protection system illustrated in a room's ceiling, according to the embodiments of FIG. 8;

FIG. 10 is an illustration of an active protection system protecting a yard confined by walls, according to some embodiments of the invention;

FIG. 11 is an illustration of an active protection system protecting a field confined by a fence, according to some embodiments of the invention;

FIG. 12 is an illustration of an active protection system protecting a corridor confined by walls, according to some embodiments of the invention;

FIG. 13 is an illustration of an active protection system protecting areas in a room confined by walls, according to some embodiments of the invention;

FIG. 14 is a flowchart illustrating a method of protecting an area against trespassers, according to some embodiments of the invention; and

FIGS. 15A, 15B, 15C are flow charts illustrating additional stages of a method of protecting an area against a trespasser, according to some embodiments of the invention.

### DETAILED DESCRIPTION OF SOME EMBODIMENTS OF THE INVENTION

Before explaining at least some embodiments of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. In other instances, well-known methods, procedures, components and circuits have not been described in detail so as not to obscure the teachings of the present disclosure.

For a better understanding of the invention, the usage of the following terms in the present disclosure are defined in a non limiting manner:

The term “Active Protection System” (APS) as used herein in this application, is defined as a system comprising the ability to affect a trespasser. The effect may be mechanical such as discharging a charge at the trespasser, acoustic such as producing different sounds or vocal notices, optical such as producing beams of light, olfactory such as producing or discharging odors at the trespasser or any other effect leading to warning, marking, neutralizing or injuring the trespasser .

The term “discharging” as used herein in this application, is defined as any action of directing, releasing, unloading or shooting a charge, splashing fluid, spraying, spreading gas, delivering electric charge on contact or from a distance, and the like. Discharging may be carried out utilizing contact between a trespasser and a protected object or independently of such a contact.

The term “trespasser” as used herein in this application, is defined as any person, animal or object that is either entering, exiting, staying in or nearing a protected area or an area defined as being within the vicinity of a protected area. The protected area may be opened or closed, may be part of a building and may or may not be clearly marked.

While certain features of the invention have been illustrated and described herein, the invention can be embodied in other forms, ways, modifications, substitutions, changes, equivalents, and so forth. The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

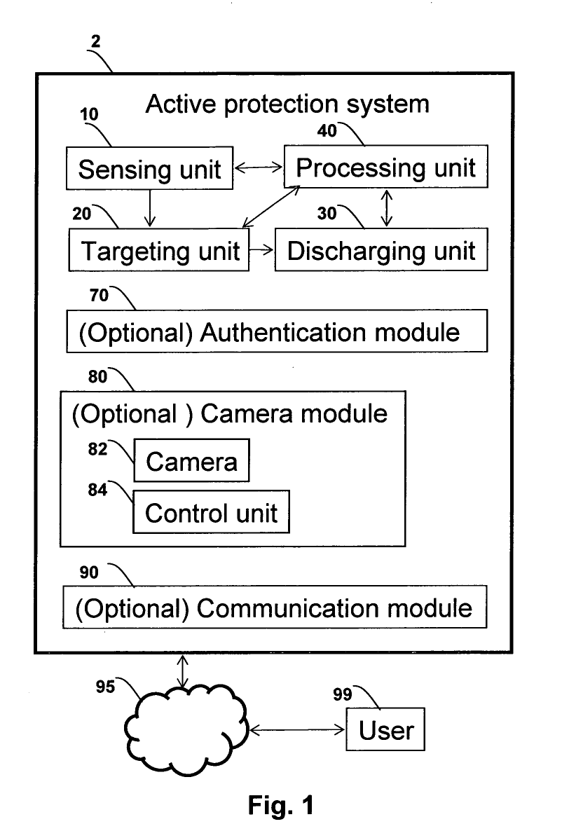

FIG. 1 is a block diagram illustrating an active protection system 2 for protecting an area against trespassers, according to some embodiments of the invention. The system may comprise a sensing unit 10, a targeting unit 20, a discharging unit 30 and a processing unit 40. Sensing unit 10 may detect the presence and the location of a trespasser in a protected area, or near at least one protected object. Sensing unit 10 may further detect motion in the protected area, or of objects in the protected area. Targeting unit 20 is arranged to target the direction of discharging unit 30 onto the trespasser, according to the presence and the location of the trespasser in the area as detected by sensing unit 10. According to embodiments, discharging unit 30 discharges (throws, splashes, spills, shoots, releases, delivers and so on) a charge (bullet, gas, fluid, paralyzing substance, neutralizing substance, electric charge and so on) onto the trespasser, into the protected area, or discharging unit 30 may emit sounds, lights, or odors for warning or paralyzing the trespasser. Processing unit 40 may be employed for performing calculations such as indicating the location of a trespasser from the information provided by sensors relating to sensing unit 10, calculating the diverting amount of the targeting unit in order to compensate on distance from the discharging outlet (barrel, nozzle, and so on) to the target.

Discharging the charge may be carried out according to the location of the trespasser in the area as detected by sensing unit 10 and targeted by targeting unit 20.

According to some embodiments of the invention, targeting unit 20 may be arranged to follow the trespasser and coordinate surveillance of the trespasser by sensing unit 10 and readiness of discharging unit 30. Processing unit 40 may be arranged to control elements in or a round the protected area such as doors, trap doors, defensive or offensive elements, as well as communicate with persons engaged in protecting the area. For example, doors may be sealed as they are approached by the trespasser.

According to some embodiments of the invention, the protected area may be defined around at least one object. Sensing unit 10 may be arranged to detect contact between the trespasser and the object. Furthermore, discharging the charge may be carried out in relation to the contact detected by sensing unit 10. For example, the charge may comprise an electric charge and discharging unit 30 may be arranged to discharge the electric charge to the trespasser via the detected contact of the trespasser and the object. Electric charge may be discharged on contact or from a distance.

According to some embodiments of the invention, the protected area may be defined as an area around an object, around a building, in from of entrances and exits, in respect to different posts and in relation to other security means and objects.

The substance or charge that is discharged at the trespasser does not necessarily have to harm the trespasser (e.g. by causing irreversible physical damages), but merely cause an undesirable physical effect such as coloring the trespasser with paint, splashing oil on the trespasser's clothes, splashing a phosphoric powder on him, and so on. By splashing a trespasser with phosphoric substance, the trespasser may be identified among a plurality of people, at least for a certain period of time after the trespassing, resulting with a threat to a potential trespasser.

The substance or charge discharged at the trespasser may paralyze or neutralize the trespasser permanently or for a predefined time period.

According to some embodiments of the invention, sensing unit 10 may be arranged to detect movements of the object, e.g. as it is moved or carried away by the trespasser. The protected area may be a space, an object, the vicinity of an object, an area such as on a wall or on the ground, predefined points and their vicinity and so forth.

According to some embodiments of the invention, the following sensors may be used to detect trespassers and to locate a trespasser within an area: a direction sensor, a direction and distance sensor, a video sensor, a combination of the indications of two or more sensors placed in a two or a three dimensional array, by a vicinity sensor, by deploying a plurality of sensors whose location is known, and so on. The direction sensor may be based on a signal transmitter, and a signal receiver. When the transmitted signal is not received at the receiver, it may indicate an obstacle between the transmitter and the receiver, which is probably due to presence of a trespasser there between. The sensor, indicating the direction and distance of an object from the sensor, may be based on dispatching a signal towards a direction, and determining the time required for receipt of the signal at the transmitter's location. According to embodiments, the system may further comprise a camera, which may take samples (shots images) periodically (e.g., every 0.2 seconds) and compare the difference between two consequent samples. The camera may also be used for indicating the direction of a trespasser in regard to the camera. The system may further comprise a vicinity sensor, which may be based on indicating a change in the magnetic field at the vicinity of the sensor, sensing contact (such as in a trap), and so on. The system may further comprise a motion sensor, which may be based on mechanical contact, interference of a laser beam and the like. The system may further comprise a mechanical motion sensor, which may be based, for example, on a metal ball placed on a vertical spring, and a ring surrounding the ball. This kind of sensor may require attaching to the protected object. A movement of the protected object (e.g. above a threshold movement intensity level), may cause the ball to touch the ring. The ball and ring may be made from conductive materials, to allow contact between these elements to result in closing an electric circuit.

According to some embodiments of the invention, sensing unit 10 may comprise at least one microphone as an acoustic sensor. Sensing unit 10 may be arranged to detect the presence and the location of a trespasser in the area by utilizing pressure waves received or detected by the microphones. Sensing unit 10 may further comprise an authentication module 70 arranged to enable the trespasser to prevent discharging unit 30 from discharging a charge by identification. Authentication module 70 may be further arranged to authenticate the identification of the trespasser. Authentication module 70 may be further arranged to utilize the microphones for receiving the identification from the trespasser. Authentication module 70 may be part of discharging unit 30 or targeting unit 20, and be arranged to enable the trespasser to prevent discharging unit 30 from discharging a charge by identification and further arranged to authenticate the identification of the trespasser. Identification and authentication may be carried out according to any identification and authentication technique and equipment known in the art such as biometric identification.

According to some embodiments of the invention, targeting unit 20 and discharging unit 30 may operate continuously upon detection of the trespasser. Targeting unit 20 and discharging unit 30 may additionally operate automatically, but may be arranged to allow manual intervention during targeting or dispatching.

According to some embodiments of the invention, the active protection system 2 may be further arranged to activate other security means in the vicinity of the protected area, such as opening or activating traps, locking doors and the like. Activation may take the form of triggering other systems of devices related, for example, to marking, capturing or neutralizing the trespasser.

According to some embodiments of the invention, discharging unit 30 is arranged to operate recurrently, being able to discharge on multiple occasions, upon different or the same trespassers at different times independently from each other.

According to some embodiments of the invention, the active protection system may further comprise a camera module 80. Camera module 80 may comprise at least one camera 82 and a control unit 84 operatively associated with camera 82. Control unit 84 may be arranged to direct camera 82 to the location of the trespasser in the area as detected by sensing unit 10. Camera module 80 may be arranged to follow the trespasser either continuously, at predefined periods or according to user instructions and control.

According to some embodiments of the invention, active protection system 2 may operate automatically. According to some embodiments of the invention, active protection system 2 may further comprise a communication module 90 arranged to allow a user 99 to control camera module 80 and discharging unit 30. Discharging unit 30 may be arranged to be remotely operated by user 99. User 99 may be allowed to remotely control targeting unit 20 and discharging unit 30. User 99 may be allowed to switch between an automatic, a manual or a semi-automatic mode. User 99 may further authenticate trespassers remotely via a communication link 95.

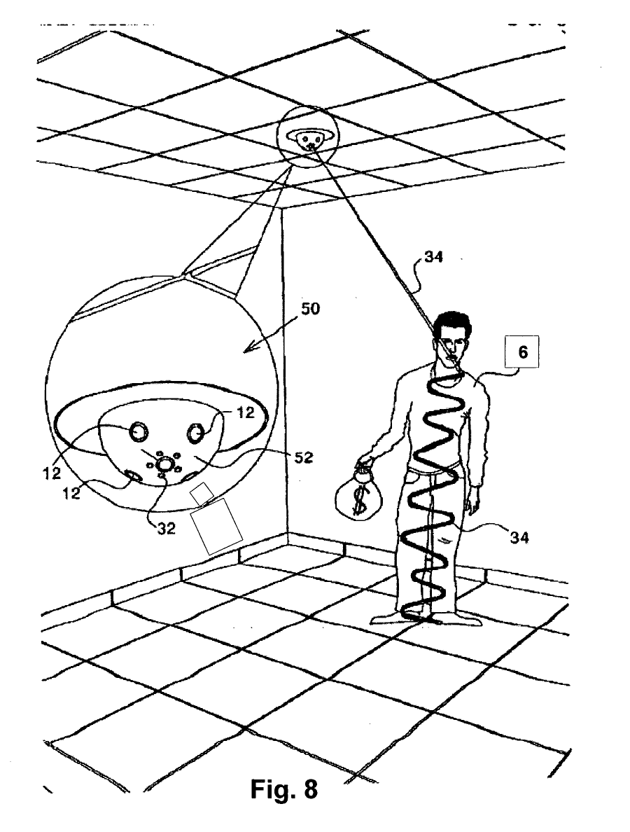

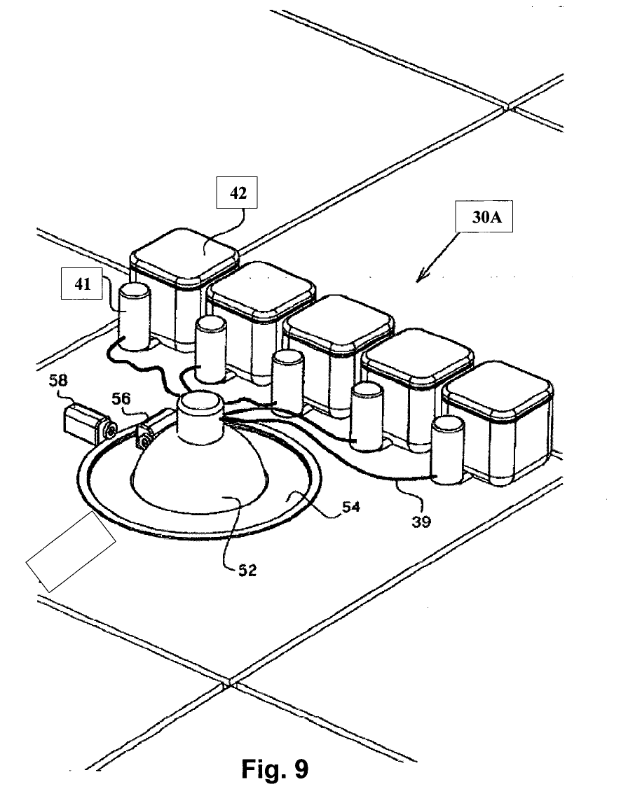

According to some embodiment of the invention, system 2 may further include a gyroscopic mechanism, which may be installed at the ceiling or on the walls of a room, which may be defined as the protected area. The sphere of the gyroscopic mechanism may be rotatable around its center (see FIG. 8 and FIG. 9 below) as known in the art. The gyroscopic mechanism may comprise a first motor, which rotates the sphere vertically (i.e., along an imaginary horizontal axis), and a second motor, which rotates the sphere horizontally (by rotating a ring which is connected to the sphere). The gyroscopic mechanism may support at least one of: sensing unit 10, discharging unit 30, targeting unit 20. One or more sensors may be deployed at the sphere, which may be part of sensing unit 10, and one or more nozzles, which may be a part of the discharging unit 30, through and from which the charge (e.g. fluidic charge such as oil or paint) may be dispensed.

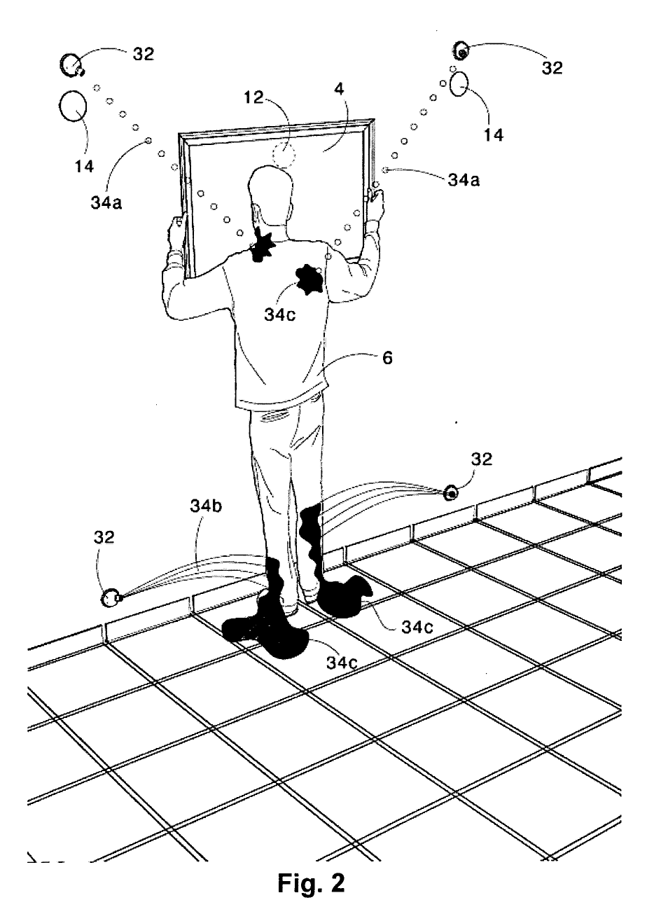

FIG. 2 is an illustration of a protected area around an object 4 (e.g. a painting) protected by an active protection system 2, according to some embodiment of the invention. In the event the presence of trespasser 6 may be identified by sensing unit 10, targeting unit 20 targets nozzles 32 on trespasser 6 (by rotating the sphere to the desired position), and splashes fluid 34a, 34b, 34c towards trespasser 6. The fluid may comprise paint, oil, glue etc., for example 34a may represent paintballs and 34b may represent a spray of oil. Sensing unit 10 may comprise a motion sensor 12, which detects motion of object 4 and a location sensor 14, which detects the location of a trespasser 6 in the vicinity of object 4.

According to some embodiment of the invention, the system may activate the operation of dispatching a charge upon detection of a movement of the protected object, upon detecting a presence of an object near the protected object, and so on.

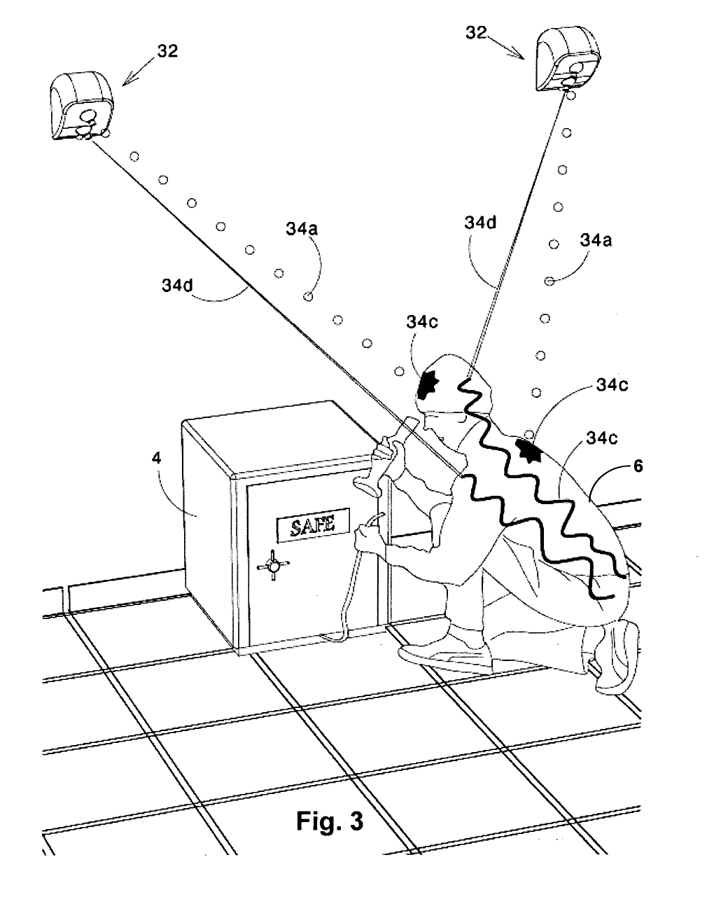

FIG. 3 is an illustration of an object 4, protected by an active protection system, according to some embodiments of the invention. In this case, the protected object 4 may be a safe. Discharging unit 30 may dispatch a plurality of charges towards a trespasser 6 (via dispatcher 32), such as paintball 34a, a spray of paint 34d, or another fluid such as oil, or glue, etc. Dispatcher 32 may be directed towards the detected location of trespasser 6, thereby upon dispatching the charge at trespasser 6, a physical contact with trespasser 6 may occur. Markings 34c may be used later on to identify trespasser 6.

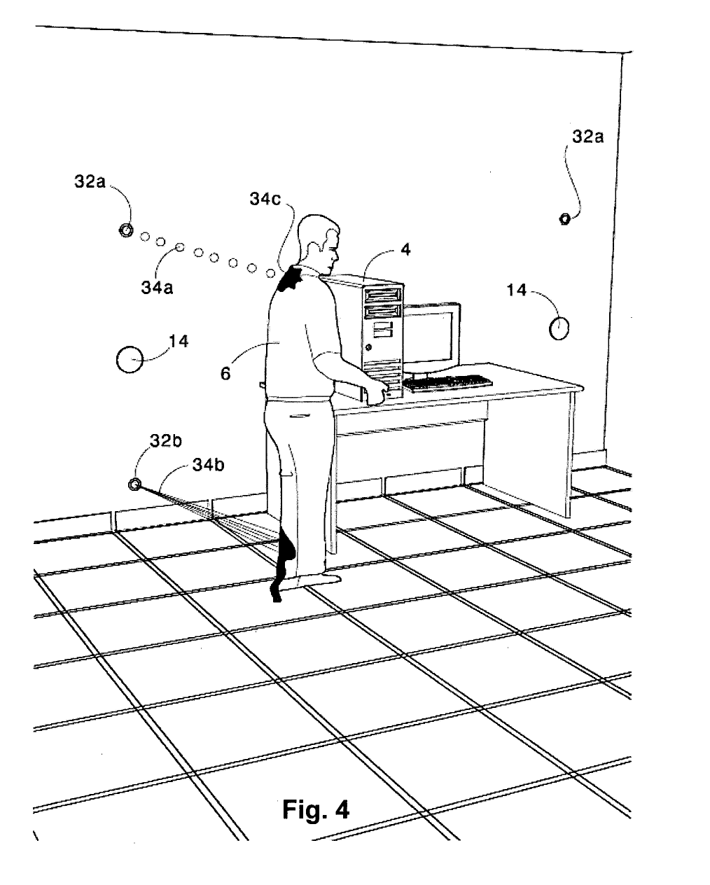

FIG. 4 is an illustration of an object 4, protected by an active protection system 2, according to some embodiments of the invention. Sensing unit 10 may comprise a location sensor 14, which detects the location of a trespasser 6 in the vicinity of object 4. Discharging unit 30 may enable dispatching at least one charge towards trespasser 6 (e.g. via dispatcher 32a), such as paintball 34a, and spray of fluid 34b such as paint, glue or oil. Markings 34c may be used later on to identify trespasser 6. In this case, the protected object 4 may be a computer or a multiplicity of objects 4. The discharging unit 30 may employ a plurality of dispatchers, such as a paintball gun 32a, and a spray dispatcher 32b. Since protection system 2 in this case employs a plurality of dispatchers, the activated dispatchers may be those placed near the trespasser.

The system may activate the operation of dispatching a charge upon detection of a movement of the protected object, upon detecting a presence of an object near the protected object.

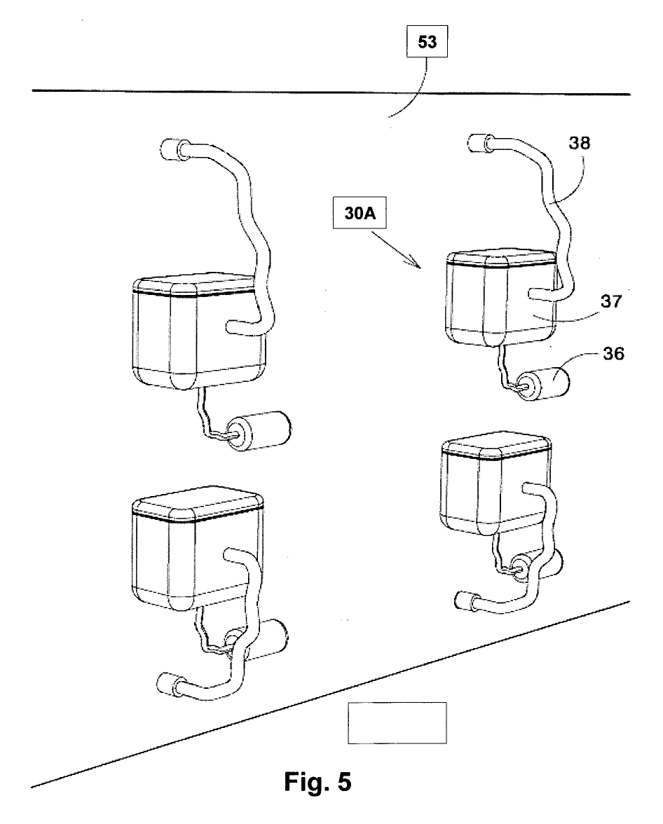

FIG. 5 is an illustration of rear view of a wall 53 on which a plurality of discharging units 30A are installed, according to some embodiments of the invention. The visible parts of discharging unit 30A in this case may comprise pumps 36 containing compressed air , a paintballs magazine 37, and a pipe 38 through which perform the operation of splashing the substance therein (e.g., paint, oil) on a trespasser.

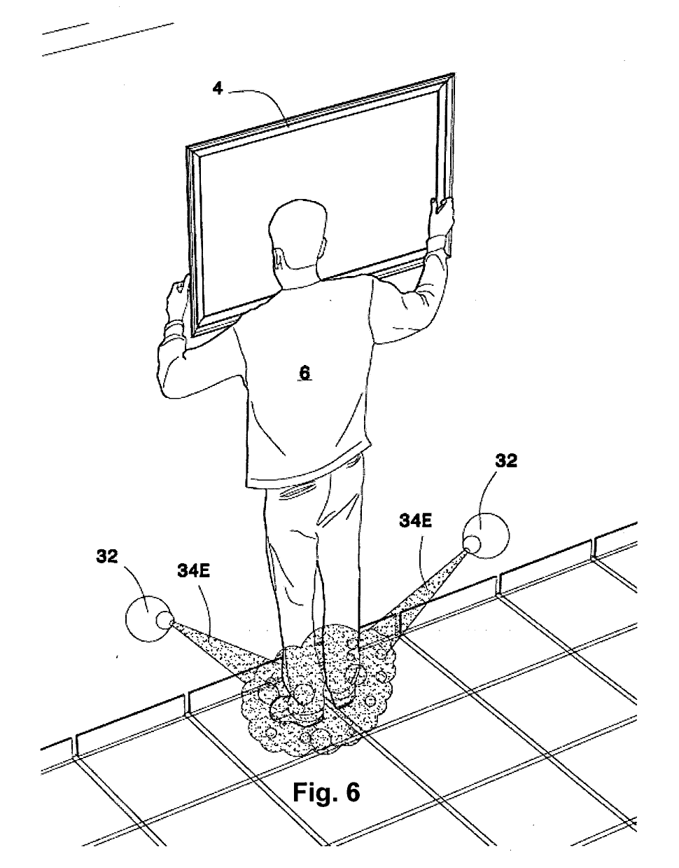

FIG. 6 is an illustration of an object 4, protected by an active protection system, according to some embodiments of the invention. The discharging unit 30 may dispatch towards a trespasser 6 (via dispatcher 32) a charge, such as foamed polyurethane 34e. The charge may harden substantially immediately after discharging and fixate trespasser 6. Since the protection system in this case employs a plurality of dispatchers, the activated dispatchers may be those placed near the trespasser.

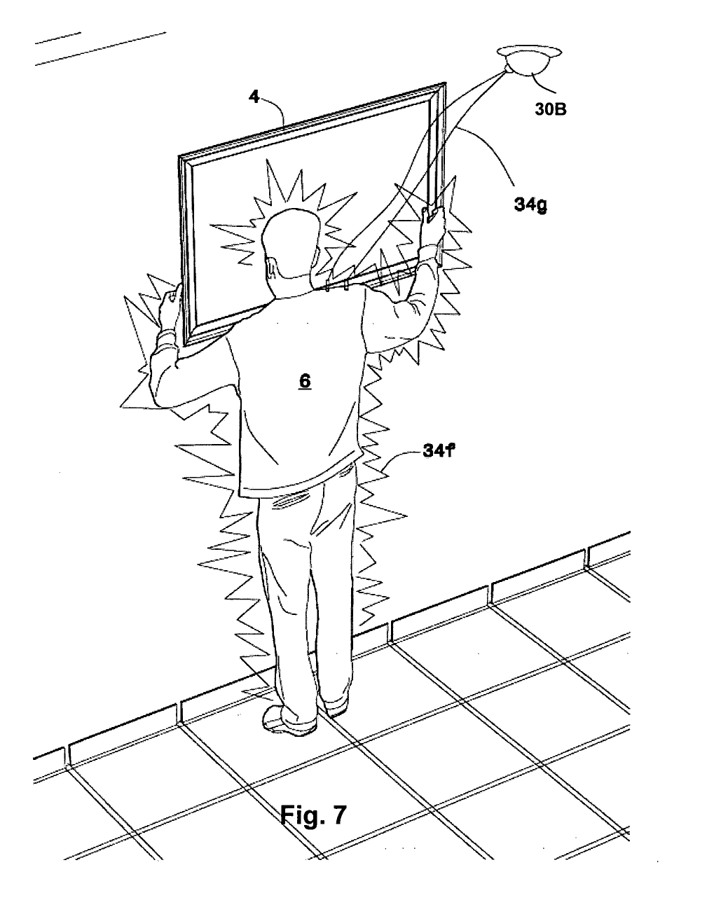

FIG. 7 is an illustration of an object 4, protected by an active protection system, according to some embodiments of the invention. An electric beam 34g may be dispatched from dispatcher 30B using a contact or a contactless method, e.g. upon touching or nearing the frame of a painting object 4. Trespasser 6 may thus be electrified by an electric charge 34f . Electric charge 34f may be delivered upon contact or from a distance. In addition, protected object 4 or a casing thereof may also be elasticized, thereby causing an electric shock to the trespasser. The location of trespasser 6 may be detected by a sensor that detects a contact between trespasser 6 and the protected object 4. If the protected object is “small” in comparison to trespasser 6 (e.g. a jewelry), the location of trespasser 6 can be determined just by activating a sensor that detects a contact between the trespasser and the protected object. However if the protected object is “big” in comparison to trespasser 6, a plurality of sensors deployed on the protected object or the vicinity thereof may be required, thereby covering the entire area where the trespasser may stand when touching the protected object.

FIG. 8 is an illustration of a room protected by an active protection system, according to some embodiments of the invention. FIG. 9 is a top view of the active protection system illustrated in FIG. 8, according to some embodiments of the invention. The block diagram illustrated in FIGS. 1 is applicable to these embodiments. A gyroscopic mechanism 50 may be installed on the ceiling or wall of the room. Sphere 52 may be rotatable around its center. The rotation mechanism of sphere 52 is illustrated in FIG. 9. Gyroscope mechanism 50 may comprise a first motor 56, which rotates sphere 52 vertically (i.e., along an imaginary horizontal axle), and a second motor 58 which rotates sphere 52 horizontally (e.g. by rotating ring 54 which may be connected to sphere 52). One or more sensors 12 may be deployed at sphere 52, which may be part of the sensing unit 10, and one or more nozzles 32, which may be part of discharging unit 30. In the event the presence of a trespasser 6 may be indicated by sensing unit 10, the targeting unit 20 targets nozzles 32 on trespasser 6 (by rotating sphere 52 to the desired position), and splash a jet of paint 34 towards trespasser 6. Marking of trespasser 6 by jet of paint 34 may reflect movements of trespasser 6 such as attempts to leave the protected area.

As illustrated in FIG. 9, the discharging unit 30A in this case comprises a plurality of paint containers 42, and pumps 41, which may perform the operation of splashing the substance therein (e.g., paint, oil) on a trespasser. Paint 34 may be propelled from paint containers 42 by pumps 41, to nozzles 32 in sphere 52, via flexible pipes 39. Pipes 39 may be flexible to allow the opening at sphere 52 change its location upon rotation of sphere 52. The direction of the splashed paint 34 may be controlled by first motor 56, rotating sphere 52 vertically, and by second motor 58, rotating sphere 52 horizontally.

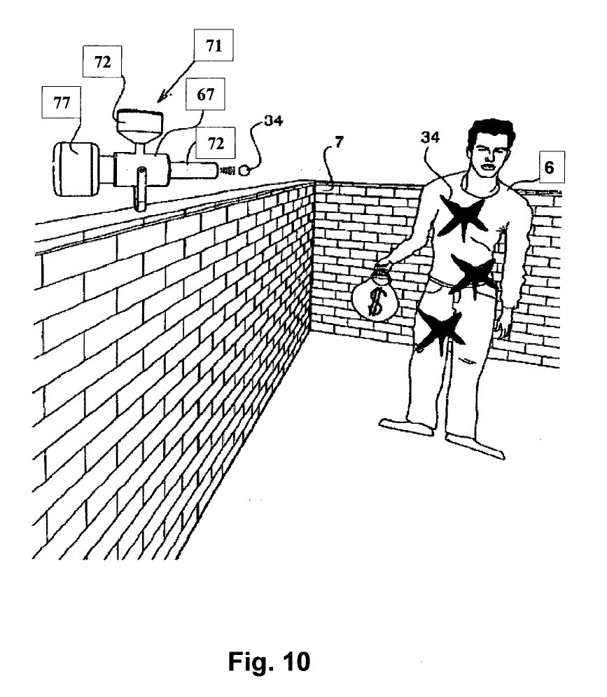

FIG. 10 is an illustration of an active protection system protecting a yard confined by walls 7, according to some embodiments of the invention. Targeting unit 20 may comprise a paint gun 67. Once the presence of a trespasser 6 is indicated by a sensing unit (not illustrated), paint gun 67 may target trespasser 6 via a targeting unit (not illustrated), and projects paint 34 onto trespasser 6. Paint gun 71 container 77 filled with condensed air, and a paint container 72. When a passage (not illustrated) between air pressure container 77 and paint container 72 opens, the air of container 77 propels paint 34 from paint container 72, through barrel. 72. It should be noted that paint gun 71 is merely an example, and other type of guns which may discharge other types of substances may be employed.

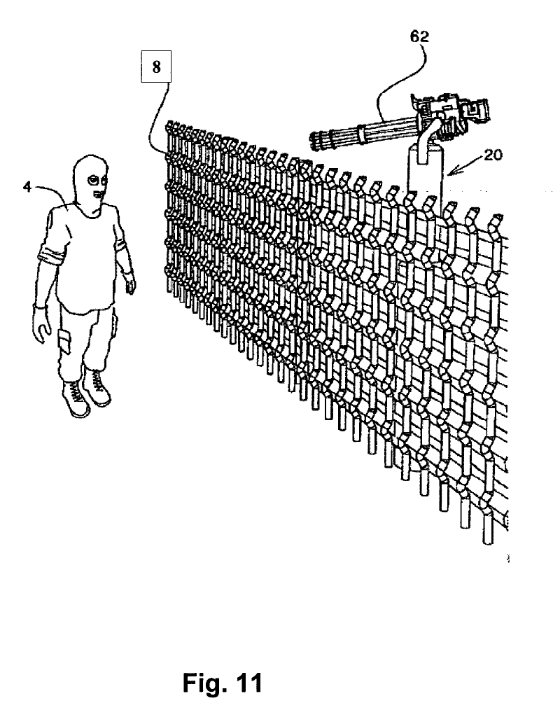

FIG. 11 is an illustration of an active protection system protecting a field confined by a fence 8, according to some embodiments of the invention. Targeting unit 20 comprises a machine-gun 62 that is activated upon detecting a trespasser 6 by a sensing unit (not shown). Targeting unit 20 locks machine-gun 62 on trespasser 6.

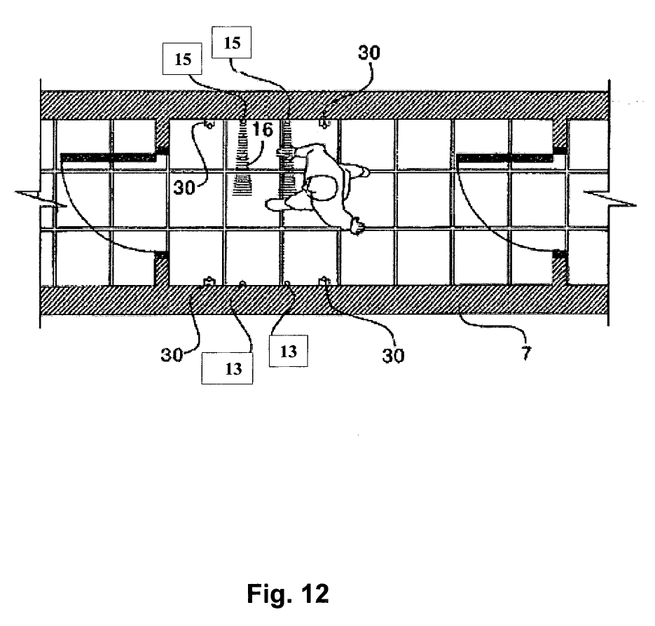

FIG. 12 is an illustration of an active protection system protecting a corridor confined by walls 7, according to some embodiments of the invention. Sensing unit 10 may comprise one or more signal transmitters 15, such as LED (Light Emission Diode), and corresponding sensors 13. Transmitter 15 and corresponding sensor 13 are deployed in opposite walls 7 of the corridor, therefore, increasing the chance to indicate presence of a trespasser that passes therebetween. Once one of sensors 13 ceases to receive the transmitted signal 16, discharging unit 30 splashes paint or other substance on the trespasser.

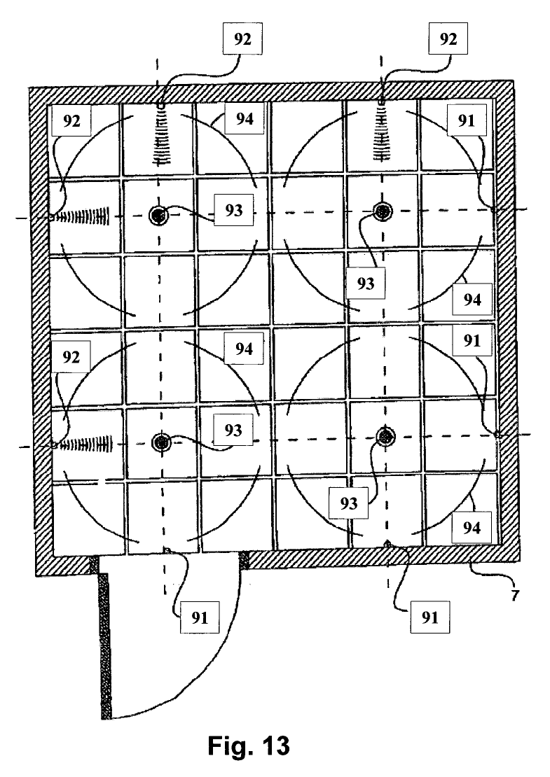

FIG. 13 is an illustration of an active protection system protecting a room confined by walls 7, according to some embodiments of the invention. As illustrated, transmitters 92 and corresponding receivers 91 may be deployed as a network, thereby indicating the location of a trespasser in the room. Once the presence of a trespasser is indicated in a specific location within the room, the nearest outlet 93 to this location may be triggered, and splash substance on the trespasser. The range 94 of the substance in relation to each outlet 93 may be indicated in the illustration.

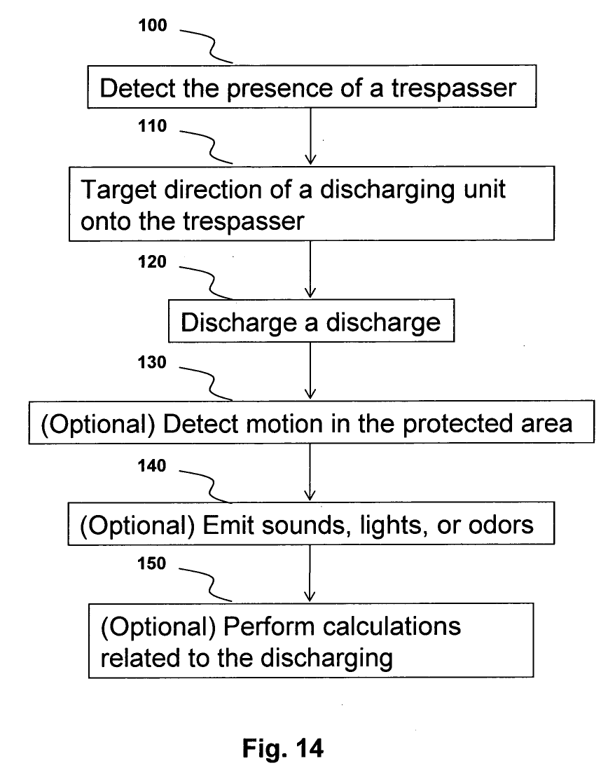

FIG. 14 is a flow chart illustrating a method of protecting an area against a trespasser, according to some embodiments of the invention. The method comprises the stages: Detecting the presence and the location of the trespasser (stage 100) in the protected area, or near a protected object; targeting the direction of a discharging unit onto the trespasser (stage 110); and discharging a charge (stage 120) onto the trespasser, into the protected area.

According to some embodiments of the invention, targeting(stage 110) may be carried out according to data from detecting the presence and the location of the trespasser by a sensor(stage 100) in the area. Discharging charges onto the trespasser (stage 120) is carried out according to targeting (stage 110).

According to some embodiments of the invention, the method may further comprise detecting motion in the protected area, or of objects in it (stage 130).

According to some embodiments of the invention, targeting the direction of a discharging unit onto the trespasser (stage 110) and discharging a charge (stage 120) onto the trespasser are carried out continuously upon detection of the trespasser (stage 100). Targeting the direction of a discharging unit onto the trespasser (stage 110) and discharging a charge (stage 120) onto the trespasser may be carried out automatically, but may be arranged to allow manual intervention during targeting (stage 110) or dispatching (stage 120).

According to some embodiments of the invention, detecting the presence and the location of the trespasser (stage 100) is carried out by at least one of: A direction sensor; a direction and distance sensor; a signal transmitter relating to a signal receiver; a camera arranged to sample and compare images; a vicinity sensor; a contact sensor; a motion sensor; a laser beam; a mechanical motion sensor; and a microphone.

According to some embodiments of the invention, at least one of the stages: detecting (stage 100); targeting (stage 110); and discharging (stage 120), may be carried out gyroscopically.

According to some embodiments of the invention, discharging a charge (stage 120) may comprise throwing, splashing, spilling, shooting, or releasing a bullet, gas, fluid, a paralyzing substance, or a neutralizing substance. Discharging a charge (stage 120) may also comprise electrocuting the trespasser either via contact with a protected object or remotely. According to some embodiments of the invention, the method may further comprise neutralizing the trespasser.

According to some embodiments of the invention, the method may further comprise emitting sounds, lights, or odors for warning or paralyzing the trespasser (stage 140).

According to some embodiments of the invention, discharging a charge (stage 120) may be carried out at a predefined distance from the protected area.

According to some embodiments of the invention, the method may further comprise distinguishing the trespasser from other persons in the vicinity of the protected area. This may be carried out by either marking the trespasser or by saving biometric data relating to the trespasser.

According to some embodiments of the invention, the method may further comprise activating security means in the vicinity of the protected area, such as opening or activating traps, locking doors and the like. Activation may take the form of triggering other systems of devices related to marking, capturing or neutralizing the trespasser.

According to some embodiments of the invention, the method may further comprise performing calculations (stage 150) related to the discharging (stage 120) such as indicating the location of the trespasser from the information provided by sensors relating to a sensing unit, or calculating the diverting amount of the targeting unit in order to compensate on distance from the discharging outlet (barrel, nozzle, and so on) to the target.

According to some embodiments of the invention, the method may further comprise calculating a direction and a range for discharging (stage 120) from sensing (stage 100) and targeting (stage 110), such that the charges encounters the trespasser.

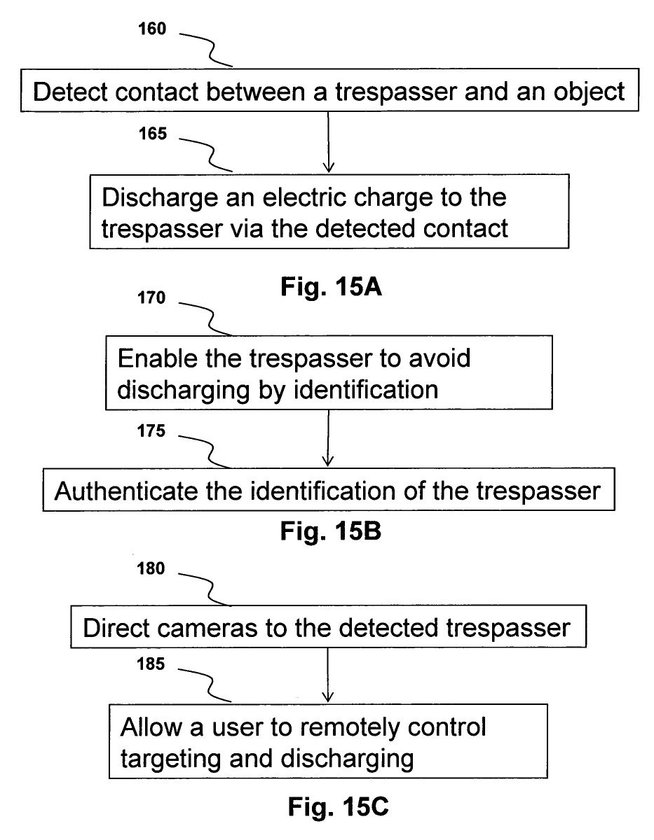

FIGS. 15A, 15B, 15C are flow charts illustrating additional stages of a method of protecting an area against a trespasser, according to some embodiments of the invention. The method may further comprise detecting contact between a trespasser and an object (stage 160). According to some embodiments of the invention, the method may further comprise discharging an electric charge at the trespasser via or in relation to the detected contact (stage 165). Delivering electric charges may be carried out on contact or from a distance.

According to some embodiments of the invention, the method may further comprise enabling the trespasser to avoid discharging by identification (stage 170). The method may further comprise authenticating the identification of the trespasser (stage 175). Enabling the trespasser to avoid discharging by identification (stage 170) may be carried out by warning the trespasser or prompting the trespasser to disclose a password. According to some embodiments, detecting the presence and the location of the trespasser (stage 100) comprises using microphones as. sensors. Pressure waves may be detected by the microphones and be utilized to detect the trespasser. In such cases, loudspeakers may be utilized to carry out the warning or prompting.

According to some embodiments of the invention, the method may further comprise directing cameras to the detected trespasser (stage 180). Further, the method may further comprise allowing a user to remotely control targeting and discharging (stage 185). The user may be allowed to switch between an automatic, manual or semi-automatic mode. The user may further authenticate trespassers remotely. The method may further comprise continuously following the trespasser with the cameras.

The present invention is considered active as it creates a physical contact with a trespasser upon detecting the trespasser inside the protected area and consequently neutralizes the trespasser and avoids the trespassing action itself.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

1. An active protection system for protecting an area against at least one trespasser comprising:
a directional sensing unit;
a targeting unit, arranged to move in at least one direction ; and
a discharging unit attached to the targeting unit_{;}
a processing unit;
wherein the directional sensing unit is arranged to continuously detect the presence, the distance and the direction of the at least one trespasser in the area;
wherein the targeting unit is arranged to continuously target the direction of the discharging unit onto the at least one trespasser, according to the presence the distance and direction of the at least one trespasser in the area as detected by the sensing unit; and
wherein the discharging unit is arranged to continuously discharge a charge onto the at least one trespasser.

2. The active protection system of claim 1, wherein the area is defined around at least one object.

3. (canceled)

4. The active protection system of claim 1, wherein the charge is an electric charge and the discharging unit is arranged to discharge the electric charge to the at least one trespasser from a distance.

5. (canceled)

6. The active protection system of claim 1, further comprising a processing unit arranged to performing calculations relating to at least one of: the operation of the sensing unit, the operation of the discharging unit, the location of the at least one trespasser, data relating to targeting the discharging unit.

7. The active protection system of claim 1, wherein the sensing unit comprises at least one of: A direction sensor; a direction and distance sensor; a signal transmitter relating to a signal receiver; a camera arranged to sample and compare images; a vicinity sensor; a contact sensor; a motion sensor; a laser beam; a mechanical motion sensor; and a microphone.

8. The active protection system of claim 1, wherein the sensing unit comprises at least one microphone, and wherein the sensing unit is arranged to detect the presence direction and distance of the at least one trespasser in the area by utilizing pressure waves detected by the at least one microphone.

9. The active protection system of claim 8, wherein the sensing unit further comprises an authentication module arranged to enable the at least one trespasser to prevent the discharging unit from discharging a charge by identification and further arranged to authenticate the identification of the at least one trespasser, and wherein the authentication module is arranged to utilize the at least one microphone for receiving the identification from the at least one trespasser.

10. (canceled)

11. The active protection system of claim 1, wherein the discharging unit is arranged to be operated recurrently.

12. The active protection system of claim 1, wherein the sensing unit further comprise an authentication module arranged to enable the at least one trespasser to prevent the discharging unit from discharging a charge by identification and further arranged to authenticate the identification of the at least one trespasser.

13. The active protection system of claim 1, wherein the charge may comprise at least one of: paint; at least one paintball; oil; glue; a capsule; a solid object; a bullet; gas; tear gas; odor, fluid; a paralyzing substance; a neutralizing substance; electric charge; and foamed polyurethane.

14. (canceled)

15. The active protection system of claim 1, further comprising camera module comprising at least one camera and a control unit, wherein the control unit is arranged to continuously direct the at least one camera to the location of the at least one trespasser in the area as detected by the sensing unit.

16. (canceled)

17. A method of protecting an area against at least one trespasser comprising:
detecting the presence, the direction and distance of the at least one trespasser in the area;
continuously targeting at least one discharging unit onto the at least one trespasser according to detected direction and distance of the trespasser; and
continuously discharging at least one charge onto the at least one trespasser at the detected direction and distance,

18. (canceled)

19. (canceled)

20. (canceled)

21. (canceled)

22. The method of claim 17, further comprising discharging an electric charge at the at least one trespasser from a distance.

23. The method of claim 17, further comprising detecting motion in the area.

24. (canceled)

25. The method of claim 17, wherein said discharging at least one charge comprises at least one of: pouring; spraying; spreading; releasing; propelling; firing; throwing; splashing; spilling; shooting; and releasing, at least one of: paint, at least one paintball, oil, glue, a capsule, a solid object, a bullet, gas, tear gas, odor fluid, a paralyzing substance, a neutralizing substance, electric charge, foamed polyurethane.

26. (canceled)

27. The method of claim 17, wherein said detecting the presence and the location of the at least one trespasser in the area is carried out by at least one of: A direction sensor; a direction and distance sensor; a signal transmitter relating to a signal receiver; a camera arranged to sample and compare images; a vicinity sensor; a contact sensor; a motion sensor; a laser beam; a mechanical motion sensor; and a microphone.

28. The method of claim 17, further comprising:
enabling the at least one trespasser to avoid said discharging by identification; and
authenticating the identification of the at least one trespasser.

29. The method of claim 17, further comprising calculating a direction and a range for said discharging at least one charge utilizing data from said detecting the presence and the location of the at least one trespasser in the area and data from said targeting at least one discharging unit onto the at least one trespasser, such that the at least one charge encounters the at least one trespasser.

30. (canceled)

31. The method of claim 17, further comprising directing at least one camera to the detected location of the at least one trespasser in the area and continuously following the at least one trespasser with the at least one camera.

32. (canceled)

33. The method of claim 17, further comprising activating security means in the vicinity of the protected area.
